(19) United States
(12) Patent Application Publication
(10) Pub. No.: US 2014/0366746 A1
(43) Pub. Date: Dec. 18, 2014

(54) AIR FRYER

(71) Applicant: Kayee Trading (Shenzhen) Co., Ltd., Shenzhen (CN)

(72) Inventor: Mo-Tsan Tsai, Shenzhen (CN)

(73) Assignee: Kayee Trading (Shenzhen) Co., Ltd., Shenzhen (CN)

(21) Appl. No.: 13/916,816

(22) Filed: Jun. 13, 2013

(51) Int. Cl. A47J 37/00

(52) U.S. Cl. CPC A47J 37/00
USPC 99/403

(57) ABSTRACT

Disclosed is an air fryer comprising a casing, an inner tank moved relative to the casing, and a handle connected to the inner tank, the inner tank comprising a food pan and a base pot accommodating the food pan, wherein the handle is provided with a first button, the interior of the handle is provided with a first grab fixing piece, one end of the first grab fixing piece is controlled to be actuated by the first button, and the other end is connected with the base pot in a manner of blocking and hooking, the first grab fixing piece is detached from the base pot by pressing down the first button, thus detaching the handle from the base pot.

### TECHNICAL FIELD

The present application relates to an air fryer, and in particular, to an air fryer with an inner tank having a handle.

### PRIOR ART

An Air fryer is an environmental and salutary fryer which cooks with a technique of high-speed air circulation, needs little or no oil and generates less smoke, and moreover, ensures nutrition in a food not to be lost with a suitable temperature.

An existing air fryer includes a casing, an inner tank and a handle connecting to the inner tank, wherein the inner tank comprises a food pan for holding foods and a base pot for accommodating the food pan. The disadvantage of such an air fryer is that the handle and the food pan or base pot are inseparable, thereby leading to an inconvenient clean for the air fryer.

### SUMMARY OF THE INVENTION

A main technical problem to be solved according to the present application is to provide an air fryer, of which a handle can be disassembled and reassembled with a food pan and a base pot.

An air fryer, comprising a casing, an inner tank moved relative to the casing, and a handle connected to the inner tank, the inner tank comprising a food pan and a base pot accommodating the food pan, wherein the handle is provided with a first button, the interior of the handle is provided with a first grab fixing piece, one end of the first grab fixing piece is controlled to be actuated by the first button, and the other end is connected with the base pot in a manner of blocking and hooking, the first grab fixing piece is detached from the base pot by pressing down the first button, thus detaching the handle from the base pot.

The handle is further provided with two second buttons, the interior of the handle is further provided with two second grab fixing pieces, one end of each second grab fixing piece is controlled to be actuated by one second button, and the other end is connected with the food pan in a manner of blocking and hooking, the two second grab fixing pieces are detached from the food pan by pressing down the two second buttons, thus detaching the handle from the food pan.

The interior of the handle is further provided with a first shaft lever having a shoulder position, two second shaft levers having a shoulder position respectively, a first spring and a second spring. One end of the first shaft lever is connected to the first button, and the other end is connected to the first spring, one end of each second shaft lever is connected to one second button, and the other ends are connected to the second spring, one end of the first grab fixing piece is abutted against the shoulder position of the first shaft lever to interlock with the first shaft lever, one end of each second grab fixing piece is abutted against the shoulder position of one second shaft lever to interlock with the second shaft lever.

The interior of the handle is further provided with a first static shaft, when pressing down the first button, the first shaft lever drives one end of the first grab fixing piece to compress the first spring, resulting in the first grab fixing piece revolving about the first static shaft, thus lifting up the other end of the first grab fixing piece away from the base pot.

The interior of the handle is further provided with a second static shaft, when pressing down the two second buttons, the two second shaft levers drive one end of the two second grab fixing pieces to compress the second spring, resulting in the two second grab fixing pieces respectively revolving about the second static shaft, thus lifting up the other ends of the two second grab fixing pieces away from the food pan.

The first grab fixing piece and the other ends of the two second grab fixing pieces are provided with a protrusion respectively, the wall of the base pot is provided with another protrusion, the wall of the food pan is provided with two through holes, the protrusion of the first grab fixing piece is matched with the protrusion of the base pot to form a grab, the protrusions of the two second grab fixing pieces are matched with the through holes of the food pan to form a grab.

The two through holes on the wall of the food pan are formed on two protrusion portions of a fastener tightly connected to the food pan.

A U-shaped groove for receiving a part of the handle is formed at the base pot, the protrusion of the food pan is formed on the inner wall of the U-shaped groove.

A beneficial effect of the present application is in that, through providing a button on the handle to connect with a grab fixing piece, the grab fixing piece and the food pan being connected by a fastener, the first grab fixing piece is detached from the base pot by pressing down the first button, thereby the handle, the food pan and the base pot can be cleaned respectively; and after cleaning, the reassembling of the handle and the food pan as well as the base pot can be completed by recombining the grab structure.

### BRIEF DESCRIPTION OF THE DRAWINGS

A further detailed description will be presented as follow with reference to specific embodiments accompanying with the drawings.

FIG. 1 is a perspective view of an air fryer according to an embodiment of the present application.

FIG. 2 is a schematic view of a separating condition that the inner tank of the air fryer shown in FIG. 1 has removed from the casing.

FIG. 3 is a sectional view of the air fryer where the handle is unseparated from the base pot and the food pan according to an embodiment of the present application.

FIG. 4 is a schematic view of a separating condition that the handle is separated from the base pot after the button shown in FIG. 3 is pressed down.

FIG. 5 is a schematic view of FIG. 4 from a different side.

FIG. 6 is a sectional view of the air fryer where the handle is unseparated from the food pan according to an embodiment of the present application.

FIG. 7 is a schematic view of a separating condition that the handle is separated from the food pan after the two buttons shown in FIG. 6 are pressed down.

FIG. 8 is a perspective view of an air fryer according to another embodiment of the present application.

### DETAILED DESCRIPTION

The present application will be further described by the following detailed description of the embodiments with the accompanying drawings.

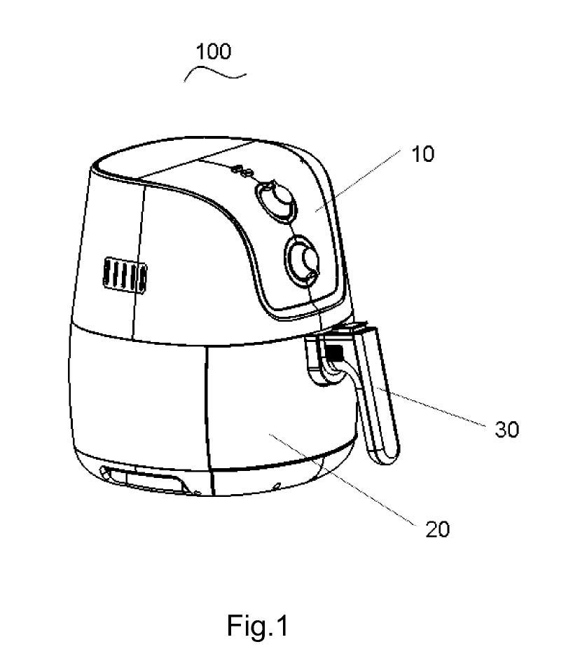

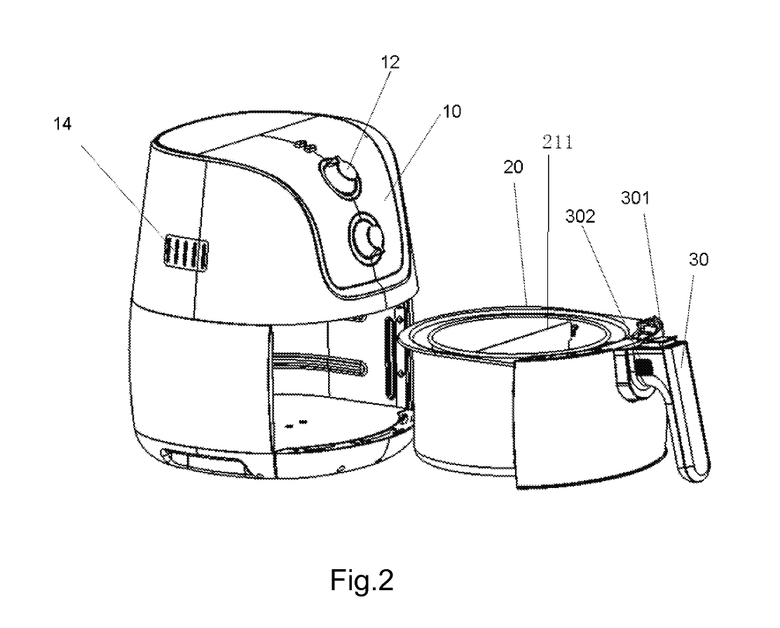

Please refer to FIG. 1 and FIG. 2, an air fryer 100 according to an embodiment of the present application comprises a casing 10, an inner tank 20 and a handle 30. The inner tank 20 and the casing 10 act as a draw-out type withdrawal structure. The handle 30 and the inner tank 20 are in demountable connection. The handle 30 is provided with a first button 301 on the upper surface thereof, and a second button 302 on two opposite side faces respectively.

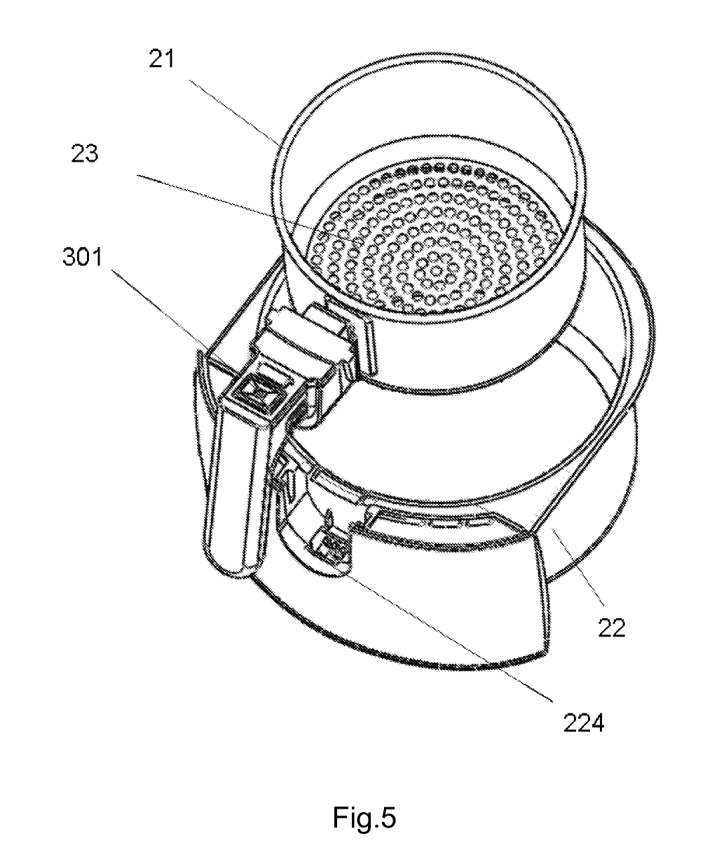

Please refer to FIG. 5, the inner tank 20 comprises a food pan 21 and a base pot 22 for accommodating the food pan 21. An insulating plate can be arranged inside the food pan 21 for insulating two kinds of food while fried, and more than one oil outlet 23 is arranged at the bottom of the food pan 21 so as to leak the fat and oil exuded from a food during cooking. The base pot 22 can be taken as an oil drip pot for the food pan 21 to hold the leaking fat and oil.

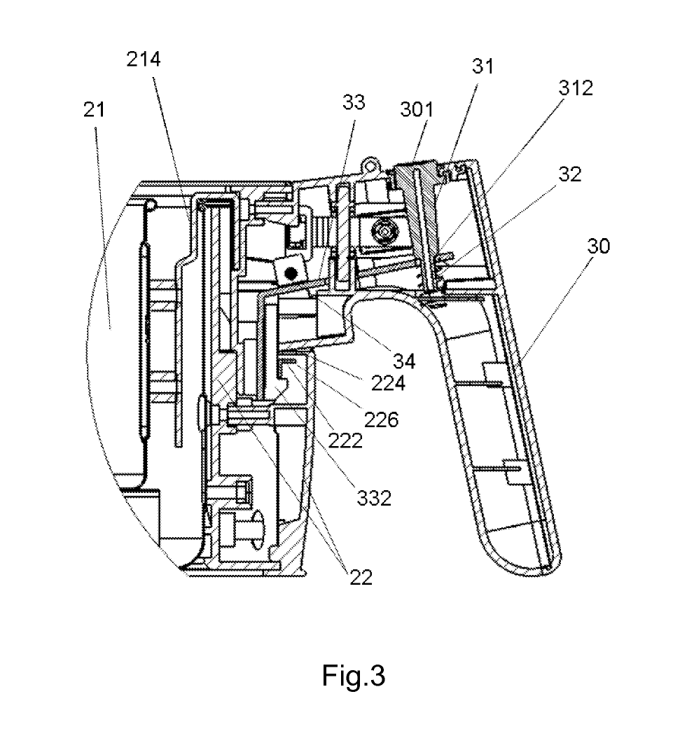

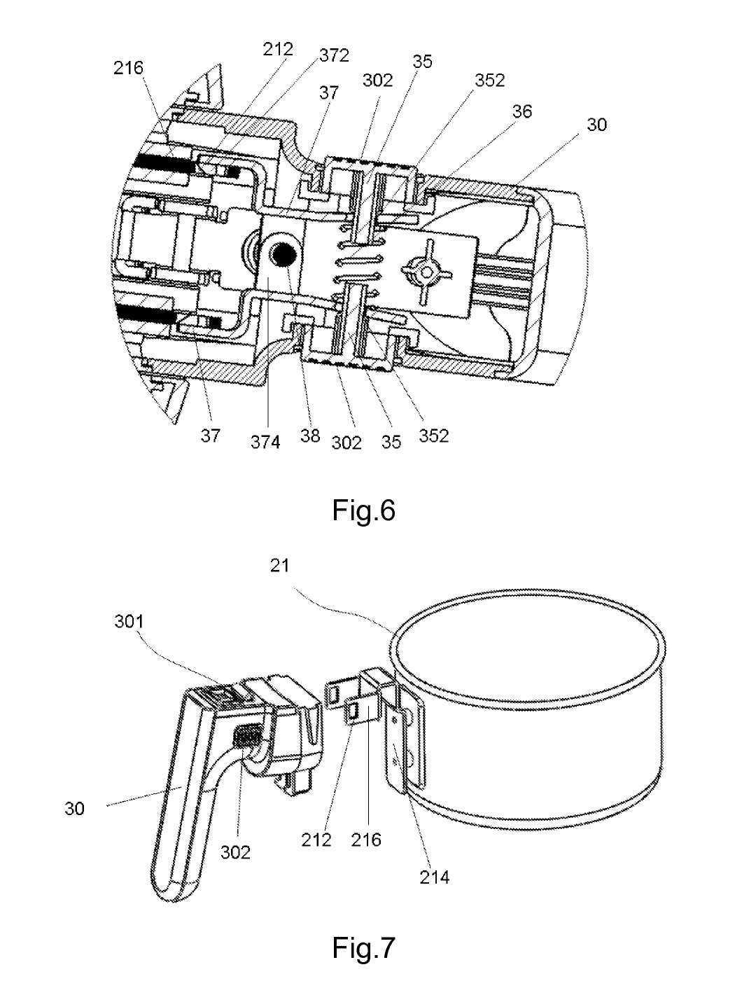

Please refer to FIG. 3, the interior of the handle 30 is provided with a first shaft lever 31, a first spring 32, a first grab fixing piece 33 and a first static shaft 34. Please refer to FIG. 6, the interior of the handle 30 is also provided with two second shaft levers 35, a second spring 36, two second grab fixing piece 37 and a second static shaft 38.

As shown in FIG. 3, one end of the first shaft lever 31 is connected to the first button 301 and the other end to the first spring 32. The first shaft lever 31 is provided with a shoulder position 312 near the other end, and one end of the first grab fixing piece 33 is abutted against the shoulder position 312. The other end of the first grab fixing piece 33 is provided with a protrusion 332. Another protrusion 222 is arranged on the wall of the base pot 22, the protrusion 332 of the first grab fixing piece 33 is matched with the protrusion 222 of the base pot 22 to form a grab.

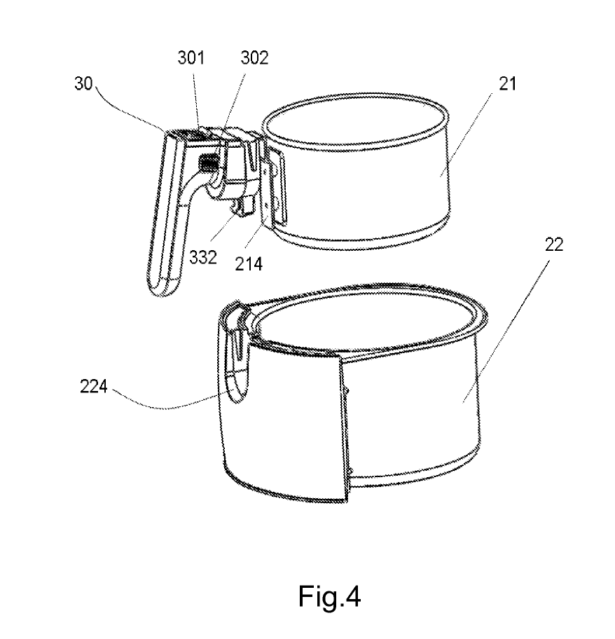

As shown in FIG. 4 and FIG. 5, the wall of the base pot 22 is provided with a U-shaped groove 224 having a hollow portion 226 downwards (as shown in FIG. 3). The U-shaped groove 224 receives a part of the handle 30, and the protrusion 222 is arranged inside the hollow portion 226.

When the first button 301 in a state shown in FIG. 3 is pressed down, the first shaft lever 31 drives one end of the first grab fixing piece 33 to compress the first spring 32, resulting in the first grab fixing piece 33 revolving about the first static shaft 34, thus lifting up the other end of the first grab fixing piece away from the base pot 22, that is, the grab formed by the protrusion 332 and the protrusion 222 is detached, in this way, the handle 30 is detached from the base pot 22.

As shown in FIG. 6, the two second shaft levers 35 are disposed opposite to each other, one end of each of the two second shaft levers 35 is connected to a second button 302 respectively, and the other end thereof is connected to the second spring 36 respectively. The two second shafts 35 are respectively provided with a shoulder position 352 near the second spring 36, and one end of each of the two second grab fixing pieces 37 is abutted against the shoulder position 352. The other end of each of the two grab fixing pieces 37 is provided with a protrusion 372. Two through holes 212 are formed on the wall of the food pan 21, the protrusions of the two second grab fixing pieces 37 match with the through holes 212 of the food pan 21 to form a grab. The two second grab fixing pieces 37 are respectively provided with an extension portion 374 which is sleeved on the second static shaft 38.

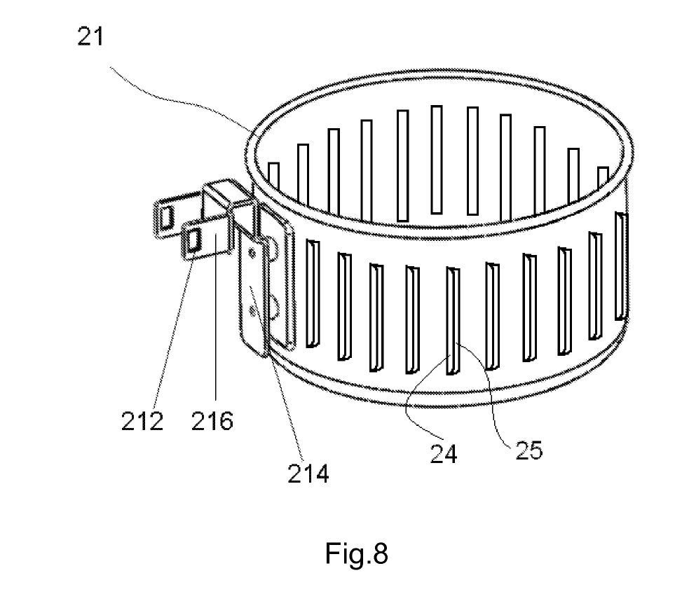

As shown in FIG. 7, the outer wall of the food pan 21 is provided with a fasten 214 having two protrusion portions 216, and the two through holes 212 are respectively formed on the two protrusion portions 216.

When the second button 302 arranged at both sides of the handle 30 in a state shown in FIG. 6 is pressed down, the two second shaft levers 35 drive one end of each of the two second grab fixing pieces 37 to compress the second spring 36, resulting in the two second grab fixing pieces 37 revolving about the second static shaft 38 respectively, thus lifting up the other end of the two grab fixing pieces 37 away from the food pan 21, that is, the protrusions 372 are detached from the through holes 212 so as to detach the handle 30 from the food pan 21.

It is easy to clean each assembly after the handle 30, the food pan 21 and the base pot 22 are detached. After cleaning, the protrusions and the through holes are matched to reassemble the handle 30 and the food pan 21 as well as the base pot 22. There is no strictly requirement for the order of disassembly and assembly, only with appropriate for easy fetch.

A computer motherboard (not shown) for controlling the air fryer 100 is provided inside the casing 10, and an operation button 12 is provided at the external of the casing 10, an air outlet 14 is arranged on the side wall and the rear wall of the casing 10.

Since the handle 30 can be detached from the base pot 22 by pressing down the first button 301, it is better for cleaning, so that in other embodiments, the two second buttons 302 can be left out, that is, an air fryer with only the first button 301 is belonged to the scope of the present application.

According to another embodiment of the present application, referring to FIG. 8, the food pan 21 may further be such a structure that, the side wall thereof is further provided with more than one oil-discharged groove 24 arranged vertically which allows the fat and oil in a food to be separated better for a healthy diet.

Further, one side of the oil-discharged groove 24 may be provided with a guiding structure 25 projected beyond the surface of the side wall. Such guiding structures in a same direction may help a full air circulation inside the pan, as well as more rapid and even heating, and more fully precipitation of grease in a food. The other structure of the air fryer of this embodiment can be similar to the previous embodiment, and need not be repeated here.

The present application has been described in details by way of above-mentioned specific embodiments, and shall not be limited to these specific embodiments. Those skilled in the art may understand that many deduction or substitutions can be made without departing from the spirit of the present application.

1. An air fryer, comprising a casing, an inner tank moved relative to the casing, and a handle connected to the inner tank, the inner tank comprising a food pan and a base pot accommodating the food pan, wherein the handle is provided with a first button, the interior of the handle is provided with a first grab fixing piece, one end of the first grab fixing piece is controlled to be actuated by the first button, and the other end is connected with the base pot in a manner of blocking and hooking, the first grab fixing piece is detached from the base pot by pressing down the first button, thus detaching the handle from the base pot.

2. The air fryer according to claim 1, wherein the handle is further provided with two second buttons, the interior of the handle is further provided with two second grab fixing pieces, one end of each second grab fixing piece is controlled to be actuated by one second button, and the other end is connected with the food pan in a manner of blocking and hooking, the two second grab fixing pieces are detached from the food pan by pressing down the two second buttons, thus detaching the handle from the food pan.

3. The air fryer according to claim 2, wherein the interior of the handle is further provided with a first shaft lever having a shoulder position, two second shaft levers having a shoulder position respectively, a first spring and a second spring, one end of the first shaft lever is connected to the first button, and the other end is connected to the first spring, one end of each second shaft lever is connected to one second button, and the other ends are connected to the second spring, one end of the first grab fixing piece is abutted against the shoulder position of the first shaft lever to interlock with the first shaft lever, one end of each second grab fixing piece is abutted against the shoulder position of one second shaft lever to interlock with the second shaft lever.

4. The air fryer according to claim 3, wherein the interior of the handle is further provided with a first static shaft, when pressing down the first button, the first shaft lever drives one end of the first grab fixing piece to compress the first spring, resulting in the first grab fixing piece revolving about the first static shaft, thus lifting up the other end of the first grab fixing piece away from the base pot.

5. The air fryer according to claim 4, wherein the interior of the handle is further provided with a second static shaft, when pressing down the two second buttons, the two second shaft levers drive one end of the two second grab fixing pieces to compress the second spring, resulting in the two second grab fixing pieces respectively revolving about the second static shaft, thus lifting up the other ends of the two second grab fixing pieces away from the food pan.

6. The air fryer according to claim 2, wherein the first grab fixing piece and the other ends of the two second grab fixing pieces are provided with a protrusion respectively, the wall of the base pot is provided with another protrusion, the wall of the food pan is provided with two through holes, the protrusion of the first grab fixing piece is matched with the protrusion of the base pot to form a grab, the protrusions of the two second grab fixing pieces are matched with the through holes of the food pan to form a grab.

7. The air fryer according to claim 6, wherein the two through holes on the wall of the food pan are formed on two protrusion portions of a fastener tightly connected to the food pan.

8. The air fryer according to claim 6, wherein a U-shaped groove for receiving a part of the handle is formed at the base pot, the protrusion of the food pan is formed on the inner wall of the U-shaped groove.

9. The air fryer according to claim 1, wherein an insulating plate is arranged inside the food pan for insulating foods.

10. The air fryer according to claim 1, wherein more than one oil outlet is arranged at the bottom of the food pan.

11. The air fryer according to claim 10, wherein more than one oil-discharged groove is arranged vertically at the side wall of the food pan.

12. The air fryer according to claim 11, wherein a guiding structure projected beyond the surface of the side wall is arranged at one side of the oil-discharged groove.
